(19) United States
(12) Patent Application Publication
(10) Pub. No.: US 2024/0182817 A1
(43) Pub. Date: Jun. 6, 2024

(54) STABLE HYPOHALITE CONCENTRATE AND DILUTION SYSTEM

(71) Applicant: THE CLOROX COMPANY, Oakland, CA (US)

(72) Inventors: Bryan Parrish, Livermore, CA (US); Evan Rumberger, San Francisco, CA (US); Kerry D. Azelton, Pleasanton, CA (US)

(21) Appl. No.: 18/074,624

(22) Filed: Dec. 5, 2022

(51) Int. Cl. C11D 3/24; C11D 1/12; C11D 3/00; C11D 3/50; C11D 7/06; C11D 7/12

(52) U.S. Cl. CPC C11D 3/24; C11D 1/12; C11D 3/0047; C11D 3/50; C11D 7/06; C11D 7/12

(57) ABSTRACT

A concentration dilution system is provided that includes a concentrated hypohalite formulation in a sealed container and that facilitates, upon combination of the concentrated hypohalite formulation with water (e.g., tap water), the formation of a dilute hypohalite formulation that can be stored in a dispensing container. The concentration dilution system can include both the concentrated hypohalite formulation in the sealed container and the dispensing container to facilitate combining the concentrated hypohalite formulation with water to form the diluted hypohalite formulation for storage in the dispensing container. Each of the concentrated and dilute hypohalite formulations have stable shelf lives, where the dilute hypohalite formulation is effective in antimicrobial and oxidative stain removal efficacy.

### FIELD

The present invention is directed toward hypohalite formulations for cleaning, stain removal, and antimicrobial uses.

### BACKGROUND

Hypohalites such as sodium hypochlorite are highly effective cleaning, bleaching and sanitizing agents used for a variety of purposes, including in the washing of certain textiles, stain removal (e.g., oxidation/whitening) of certain textiles or surfaces, the cleaning and disinfecting and/or sanitizing of surfaces or items (e.g., destruction of bacteria and/or viruses), the removal of mold and mildew from certain surfaces, etc.

Bleach formulations (e.g., aqueous solutions containing sodium hypochlorite) are particularly useful and common in both industrial and domestic applications, with many households typically containing some form of bleach solution for laundry and cleaning uses.

Given the varied uses of hypohalite solutions, it would be advantageous to provide a hypohalite solution in concentrated form that facilitates dilution with water to form a less concentrated or dilute hypohalite solution for the uses as noted herein. Thus, a small volume of a concentrated hypohalite solution can be provided to form a much greater volume diluted solution that is still effective for use. However, a highly concentrated hypohalite solution would not be stable for long periods of time, particularly when combined with other agents such as surfactants and fragrances. In addition, depending upon the mineral content of the water used for dilution of the concentrated solution (e.g., hard water content having a high mineral content), this may also impact the stability of the dilute hypohalite solution.

Accordingly, it would be advantageous to provide a concentrated hypohalite solution or formulation that is stable prior to dilution and also a system that facilitates formation of a dilute hypohalite formulation from the concentrated formulation that is also stable for an extended period of time.

### BRIEF SUMMARY

In accordance with embodiments described herein, a concentration dilution system is provided that comprises a concentrated hypohalite formulation in a sealed container and that facilitates, upon combination with water (e.g., tap water), the formation of a dilute hypohalite formulation that can be stored in a dispensing container. The concentration dilution system can include both the concentrated hypohalite formulation in the sealed container and the dispensing container to facilitate combining the concentrated hypohalite formulation with water to form the diluted hypohalite formulation for storage in the dispensing container.

In an example embodiment, a concentrate dilution system comprises a sealed container containing a concentrated hypohalite formulation, where the concentrated hypohalite formulation comprises about 2% to about 10% by weight of a sodium hypochlorite, about 0.2% to about 5% by weight of a pH adjusting agent comprising one or more selected from the group consisting of a carbonate, a hydroxide, and any combinations or mixtures thereof, about 0.1% to about 2% by weight of an anionic surfactant, and about 85% to 95% by weight of treated water, where the concentrated hypohalite formulation has a pH of about 12-14 and has an initial concentrated sodium hypochlorite level that is maintained at greater than 50% of the initial concentrated sodium hypochlorite level after 48 hours at 60° C. The concentrate dilution system further comprises a dispensing container having a greater volume than the sealed container, which is formatted to contain a stable dilute hypohalite formulation, the dilute hypohalite formulation comprising the concentrated hypohalite formulation, and a tap water, and further where the dilute hypohalite formulation has a pH of about 11-13 and is a 1:10-1:20 dilution of the concentrated hypohalite formulation with the tap water and the dilute hypohalite formulation includes sodium hypochlorite in a reduced amount of no greater than about 1% by weight.

In another example embodiment, a concentrate dilution system comprises a sealed container containing a concentrated hypohalite formulation, where the concentrated hypohalite formulation comprises about 2% to about 10% by weight of a sodium hypochlorite, about 0.2% to about 5% by weight of a pH adjusting agent comprising one or more selected from the group consisting of a carbonate, a hydroxide, and any combinations or mixtures thereof, about 0.1% to about 2% by weight of an anionic surfactant, about 0.0001 to about 0.01% of a stability agent comprising a polyacrylate, and about 85% to 95% by weight of treated water, where the concentrated hypohalite formulation has a pH of about 12-14 and has an initial concentrated sodium hypochlorite level that is maintained at greater than 50% of the initial concentrated sodium hypochlorite level after 48 hours at 60° C. The concentrate dilution system further comprises a dispensing container having a greater volume than the sealed container, which is formatted to contain a stable dilute hypohalite formulation comprising the concentrated hypohalite formulation, and a tap water, where the dilute hypohalite formulation has a pH of about 11-12 and is a 1:10-1:20 dilution of the concentrated hypohalite formulation with the tap water and has an initial dilute sodium hypochlorite level that retains greater than 50% of the initial dilute sodium hypochlorite level after 168 hours at 60°.

In a further example embodiment, a concentrate dilution system comprises a sealed container containing a concentrated hypohalite formulation, where the concentrated hypohalite formulation comprises about 2% to about 10% by weight of a sodium hypochlorite, about 0.2% to about 5% by weight of a pH adjusting agent comprising one or more selected from the group consisting of a carbonate, a hydroxide, and any combinations or mixtures thereof, about 0.1% to about 2% by weight of an anionic surfactant, about 0.01 to about 1% of a fragrance, and about 85% to 95% by weight of treated water, where the concentrated hypohalite formulation has a pH of about 12-14 and has an initial concentrated sodium hypochlorite level that is maintained at greater than 50% of the initial concentrated sodium hypochlorite level after 48 hours at 60° C. The concentrate dilution system further comprises a dispensing container having a greater volume than the sealed container, which is formatted to contain a stable dilute hypohalite formulation, the stable dilute hophalite formulation comprising the concentrated hypohalite formulation, and a tap water, where the dilute hypohalite formulation has a pH of about 11-12 and is a 1:10-1:20 dilution of the concentrated hypohalite formulation with the tap water and has an initial dilute sodium hypochlorite level that retains greater than 50% of the initial dilute sodium hypochlorite level after 168 hours at 60° and the dilute hypohalite formulation includes sodium hypochlorite in a reduced amount of no greater than about 1% by weight.

Embodiments described herein also include methods of facilitating the formation of a dilute hypohalite formulation from a concentrated hypohalite formulation with tap water and that is shelf stable as described herein.

The above and still further features and advantages of the present invention will become apparent upon consideration of the following detailed description of specific embodiments thereof.

### BRIEF DESCRIPTION OF THE DRAWINGS

FIG. 1 is a plot of Mold Decolorization vs. Hypochlorite Concentration demonstrating efficacy in mold treatment with dilute hypohalite formulations as described herein.

### DETAILED DESCRIPTION

In the following detailed description, while aspects of the disclosure are disclosed, alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The terms “comprising,” “including,” “having,” and the like, as used herein, are synonymous and are open-ended terms that do not exclude additional, unrecited elements or method steps. The term “consisting of”, as used herein, excludes any element or method step that is not specified in a claim. The term “consisting essentially of”, as used herein, limits the scope of a claim to specific recited elements and method steps and as well as unrecited elements and unrecited steps that do not materially affect the basic and novel characteristics of the claimed invention. The terms “a” and “an” can refer to plural elements unless clearly indicated otherwise (e.g., “an excipient” can include, one, two or more excipients).

The term “effective amount”, as used herein, generally refers to amounts described within ranges as noted herein. Also, unless indicated otherwise, the term “percentage”, as used herein, refers to a weight percent based upon a particular material that is referenced. For example, an excipient, active ingredient or component that is present in an amount of 1% of a formulation or other composition indicates that the excipient, active ingredient or other component is present in the formulation or composition as 1% by total weight of the formulation or composition. Such term is also referred to herein as “wt %” or “% by weight”. Similarly, the term “ppm” refers to parts per million on a weight/weight basis, such that, e.g., 100 ppm refers to 0.01% by weight (or 0.01 wt %). Further, the term “about” as used herein in relation to a described amount indicates that the amount can deviate or vary slightly beyond the described value by no more than 5% (e.g., “about 1% by weight” also includes a range of 0.95-1.05% by weight) while substantially maintaining the same efficacy of the formulation. In addition, the term “formulation”, as used herein (e.g., a concentrated or a dilute hypohalite formulation), refers to an aqueous liquid composition including two or more ingredients or components.

The term“treated water”, as used herein, generally refers to water that undergoes a process that improves the quality or consistency of the water to make it appropriate for a specific end-use. In the context of the present invention, treated water is water that is suitable for incorporation into a concentrate dilution system. The water may be treated to remove a wide variety contaminates, including but not limited to: bacteria, viruses, microbes, metals, minerals, chemicals, sediment, solids and other any other suitable contaminants. Treated water includes deionized water, distilled water, reverse osmosis water, soft water, filtered water, and water which maybe treated by another suitable method for removal or inactivation of contaminates.

In accordance with example embodiments, a stable concentrated hypohalite formulation is described that can be used in a diluted form for purposes of cleaning, removing stains from and/or bleaching textiles or other items, sanitizing and/or sterilizing objects or surfaces. In particular, a combined hypohalite concentrate/dilution system can be provided that enables a product for use (in residential and/or industrial environments) in which the concentrated formulation is diluted prior to use.

As described herein, the concentrated hypohalite formulation is stable (i.e., substantially maintains the amounts of most or all components within the formulation without degradation of such components) for a sufficient time period prior to being activated for use by the addition of water to form the dilute hypohalite formulation. The storage container for the concentrated hypohalite formulation can comprise a small sealed container or pod that can be stored for an extended period of time (e.g., shelf life up to one year or longer) prior to activation/dilution. After addition of water to form a dilute hypohalite formulation, the dilute hypohalite formulation can also be stored for an extended period of time (e.g., shelf life up to one year or longer) and remain stable prior to being used.

To be effective for oxidative stain removal, bleaching formulations often require sodium hypochlorite in an amount of 1-2% by weight in an aqueous solution. A concentrate that would dilute to this amount of sodium hypochlorite would require a much greater amount of sodium hypochlorite in the concentrate. For example, an effective concentrate that would form a dilute 1-2% bleach formulation would typically require a 12×, or 12-24% bleach formulation (i.e., aqueous solution containing 12-24% by weight of sodium hypochlorite). Such a heavily concentrated bleach formulation would not be stable for extended periods of time, particularly with the addition of a surfactant and/or a fragrance to the bleach formulation.

It has been determined that effective bleaching/oxidative stain removal properties can be achieved at hypohalite formulations described herein that include significantly lower amounts of hypohalite within each of the concentrated and dilute formulations, where the concentrated formulations can include, e.g., a hypohalite such as sodium hypochlorite in an amount no greater than about 13.5% by weight of the concentrated formulation and in an amount no greater than about 1% by weight of the dilute formulation, and preferably less than about 1% by weight of the dilute formulation.

The buffer system, including one or more pH adjusting agents, has also been found to be important in maintaining stability and effectiveness of the hypohalite formulations described herein. In particular, a buffer system is provided in the hypohalite formulations that lowers and maintains the pH of the dilute hypohalite formulations and further results in more effective oxidative stain removal at the lower hypohalite concentration. The buffer system can include one or a variety of surfactants, preferably anionic surfactants as described herein.

It has further been determined that the stability of the dilute hypohalite formulation formed as described herein is maintained regardless of the water hardness in the aqueous composition, such that tap water may be utilized to dilute the concentrated hypohalite formulation without significant degradation of the dilute hypohalite formulation. As used herein, “tap water” refers to water from a faucet or tap that may be provided from a municipality or other local source (e.g., well water) and that has not been purified, distilled or otherwise treated. In example embodiments, a polyacrylate is provided as a stability agent in the hypohalite solutions in an effective amount to minimize any effect of impurities such as minerals (e.g., calcium and magnesium) in hard water that might otherwise degrade one or more components or ingredients of the hypohalite formulations.

In example embodiments, the amount of available halide oxidant can be provided in any suitable manner within the concentrated and/or dilute formulations. In the example embodiments described herein, hypochlorite is added in a formulation so as to provide free available chlorine as an active ingredient in solution for performing bleaching, stain removal, and cleaning (e.g., sanitizing and/or disinfecting) operations during use of the formulations. However, other halides can be alternatively added or even added in addition to chloride oxidant so as to provide similar efficacy at the same or similar dosage amounts and in similar formulations (e.g., utilizing similar buffer systems, similar surfactants, etc.). The halides can be added as hypohalites (i.e., salts of hypohalous acids) to form formulations as described herein. Alternatively, any other suitable form of halide can be added to facilitate generation of solubilized active halide within a formulation. Examples of suitable halide oxidants that can be present in formulations as described herein include, but without limitation, hypochlorous acid, hypobromous acid, alkaline metal salts and/or alkaline earth metal salts of hypochlorous acid, alkaline metal salts and/or alkaline earth metal salts of hypobromous acid, solubilized chlorine, solubilized bromine and/or any other solubilized halide, solubilized chlorine dioxide, sodium chlorite, any other suitable active chlorine compounds or other active halide compounds, and any combinations thereof.

The amount of halide oxidant component (broadly referred to herein as a hypohalite or free available halide oxidant) is many times greater (e.g., 10× to 20× greater) in the concentrated formulation in comparison to the dilute formulation. In example embodiments, a concentrated hypohalite formulation (e.g., formulation with hypochlorite) comprises from about 1% to about 13.5% by weight (i.e., by weight of the concentrated formulation), such as from about 1.2% to about 11% by weight, or from about 2% to about 10% by weight, or from about 2% to about 6% by weight, or from about 3% to about 9% by weight, or from about 4% to about 9% by weight, or even from about 4% to about 6% by weight.

Upon addition of water to the concentrated formulation, hypohalite is present in the dilute hypohalite formulation (e.g., formulation with hypochlorite) in an amount no greater than about 1% by weight (i.e., by weight of the dilute formulation), or less than about 1% by weight. In particular, dilute hypohalite formulations may comprise hypohalite in an amount from about 0.1% to about 1.0% by weight (i.e., by weight of the dilute formulation), or from about 0.4% to about 1.0% by weight, or from about 0.1% to about 0.9% by weight, or from about 0.1% to about 0.7% by weight, or from about 0.2% to about 0.7% by weight, or from about 0.3% to about 0.6% by weight, or even from about 0.4% to about 0.5% by weight.

In forming the dilute hypohalite formulations as described herein, the dilution ratio can be at least 1:5, where water is added to the concentrated formulations so as to increase the total formulation volume (and also reduce the amounts in weight percentages of each component) by a factor of at least 5. For example, depending upon particular applications of use and how the concentrated formulations are provided, the 1:X dilution ratio of the concentrated hypohalite formulation with water to form dilute hypohalite formulation (i.e., unit volume of concentrated hypohalite formulation to unit volume of dilute hypohalite formulation after the addition of water) can be 1:10, 1:11, 1:12, 1:13, 1:14, 1:15, 1:16, 1:17, 1:18, 1:19 and 1:20 or even greater. Since the dilution is with water, a corresponding decrease in weight percentage of the hypohalite as well as other ingredients or components can be decreased by a similar ratio (e.g., a 1:10 dilution ratio will achieve about a 10× reduction in concentration as measured by weight percentage of hypohalite from concentrated formulation to dilute formulation).

The buffer system can include any one or more buffering or pH adjusting agents that provide a stable formulation at a desired pH. In particular, the one or more pH adjusting agents for the buffer system are present in the concentrated formulation in an amount no greater than about 5.0% by weight (i.e., by weight of the concentrated formulation) and are present in the dilute formulation in an amount no greater than about 0.30% by weight (i.e., by weight of the dilute formulation). Suitable pH adjusting agents that can be provided in the buffer system include silicate salts (e.g., sodium silicate, sodium metasilicate, sodium orthosilicate, potassium silicate, potassium metasilicate, potassium orthosilicate, etc.), phosphate salts (e.g., sodium phosphate, sodium polyphosphate, potassium phosphate, potassium polyphosphate, etc.), carbonate salts (e.g. sodium carbonate, sodium bicarbonate, potassium carbonate, potassium bicarbonate, etc.), borate salts (e.g., sodium borate, potassium borate, etc.), and combinations or mixtures thereof. Suitable pH adjusting agents can also include acids or bases such as hydroxides (e.g., sodium hydroxide, potassium hydroxide, etc.). In particular, the buffer system can comprise a combination of pH adjusting agents comprising a carbonate and a hydroxide (e.g., sodium carbonate and sodium hydroxide).

The amount of one or more pH adjusting agents within the concentrated hypohalite formulation can be from about 0.2% to about 5.0% by weight (i.e., by weight of the concentrated formulation), or from about 0.2% to about 2.5% by weight, or from about 0.2% to about 2.0% by weight, or from about 0.5% to about 1.5% by weight, or from about 0.8% to about 1.4% by weight. The amount of one or more pH adjusting agents within the dilute hypohalite formulation can be from about 0.025% to about 0.30% by weight (i.e., by weight of the dilute formulation), or from about 0.025% to about 0.28% by weight, or even from about 0.03% to about 0.25% by weight.

The buffer systems can also include one or more stability agents. Providing certain stability agents, such as one or more polyacrylates, to the concentrated hypohalite formulation or to the dilute hypohalite formulation is particularly important to ensure stability of the dilute formulation regardless of the hardness of water being added to form the dilute formulation. This allows a user/consumer to form the dilute formulation from the concentrated formulation without the requirement of using purified/distilled water. Instead, tap water (e.g., water provided from a public utility or locally sourced, e.g., well water) can be used to form the dilute the concentrated hypohalite formulation without the concern of significant degradation of the dilute hypohalite formulation for an extended period of time. A non-limiting example of a specific embodiment of an acrylate that is suitable for enhancing the stability of the dilute hypohalite formulation that includes tap water is a sodium polyacrylate compound that is commercially available under the tradename SOKALAN PA 25 CL PN (BASF, Germany).

The amount of one or more stability agents can be provided in the concentrated formulation in an amount ranging from about 0.0005% to about 1% by weight (i.e., by weight of the concentrated formulation), or from about 0.0005% to about 0.1% by weight, or from about 0.001% to about 0.05% by weight, or from about 0.001% to about 0.03% by weight, or from about 0.001% to about 0.02% by weight, or even from about 0.001% to about 0.01% by weight. The amount of one or more stability agents can be provided in the dilute formulation in an amount ranging from about 0.00003% to about 0.001% by weight (i.e., by weight of the dilute formulation), or from about 0.00005% to about 0.001% by weight, or from about 0.00006% to about 0.0001% by weight.

One or more surfactants and, in particular, one or more anionic surfactants, are provided in the formulations to enhance uniform distribution, uniform wetting and/or uniform penetration properties of the formulations as well as the micro efficacy of the formulations in the diluted form during use. Examples of suitable anionic surfactants that can be provided in the formulations include, without limitation, sulfates such as alkyl sulfates (e.g., C₈-C₁₈ linear or branched alkyl sulfates such as sodium lauryl sulfate (SLS), and sodium tetradecylsulfate), sulfonates such as alkyl sulfonates (e.g., C₆-C₁₈ linear or branched alkyl sulfonates such as sodium octane sulfonate and sodium secondary alkane sulfonate, alkyl ethoxysulfates, fatty acids and fatty acid salts (e.g., C₆-C₁₆ fatty acid soaps such as sodium laurate), and alkyl amino acid derivatives. Other examples may include sulfate derivatives of alkyl ethoxylate propoxylates, alkyl ethoxylate sulfates, alpha olefin sulfonates, C₆-C₁₆ acyl isethionates (e.g. sodium cocoyl isethionate), C₆-C₁₈ alkyl, aryl, or alkylaryl ether sulfates, C₆-C₁₈ alkyl, aryl, or alkylaryl ether methylsulfonates, C₆-C₁₈ alkyl, aryl, or alkylaryl ether carboxylates, sulfonated alkyldiphenyloxides (e.g. sodium dodecyldiphenyloxide disulfonate), and the like. A non-limiting example embodiment of a specific anionic surfactant that can be provided in the formulations as described herein is an Alkyldiphenyloxide Disulfonate commercially available under the tradename DOWFAX 2A1 (Dow Inc., Michigan).

The one or more surfactants (e.g., one or more anionic surfactants) can be provided in the concentrated formulations in an amount from about 0.1% to about 2% by weight (i.e., by weight of the concentrated formulation), or from about 0.2% to about 1.9% by weight. The one or more surfactants in the dilute formulations can be in an amount from about 0.01% to about 0.15% by weight, or from about 0.02% to about 0.13% by weight.

Any other one or more suitable excipients or other additives can also be provided within the formulations depending upon a particular application of use. For example, one or more of dyes or other colorants can be added to provide an aesthetically pleasing look for the formulations. One or more thickeners may also be added depending upon a particular use. Enzymes can also be added (e.g., to enhance cleaning operations). Further, one or more fragrances can be added to the formulations in any suitable amount to mask or disguise the bleaching odor and/or to provide another aesthetically pleasing odor or smell to the formulations. An added fragrance to be added is rendered relatively stable in the presence of the hypohalite within the formulation, based upon its chemical structure as well as by assistance from the buffer system components also present in the formulation. Non-limiting examples of suitable fragrances include essential oils (e.g., from botanical or other naturally derived sources), synthetic fragrance oils and/or any other suitable type of fragrance composition that is stable at the concentration level of the concentrated and/or dilute hypohalite formulations, where the fragrance compositions are preferably rendered substantially miscible in the aqueous based formulations. One or more fragrances may be provided in the concentrated hypohalite formulation in an amount from about 0.01% to about 1% by weight (i.e., by weight of the concentrated formulation), or from about 0.02% to about 0.2% by weight. Upon dilution, the amount of one or more fragrances in the dilute hypohalite formulation can be from about 0.001% to about 0.05% by weight (i.e., by weight of the dilute formulation), or from about 0.002% to about 0.03% by weight.

The amount of water present in the hypohalite concentrated formulation can be from about 80% to about 95% by weight (i.e., by weight of the concentrated formulation), or from about 85% to about 95% by weight, or from about 90% to about 95% by weight. The water provided in the concentrated formulation is treated water.

As previously noted herein, the concentrated formulation can be diluted with any source of water, including tap water (i.e., water that has not been distilled or treated to remove minerals or other impurities). Depending upon the dilution ratio desired and/or configured for implementing with the concentrated formulation, the amount of water (e.g., tap water) that is within the dilute hypohalite formulation can be from about 80% to about 98% by weight (i.e., by weight of the dilute formulation), or from about 90% to about 98% by weight, or even about 95% to about 98% by weight. Thus, the vast majority of the formulations, both concentrated and dilute, contain water and further can contain tap water.

The pH of the concentrated and dilute formulations can be selectively controlled based upon the amount of hypohalite as well as the amount and/or types of pH adjusting agents provided in the formulations. In example embodiments, the concentrated formulations are prepared so as to have a pH of at least about 12, such as a pH from about 12 to about 14. The pH of the dilute formulations is lower than that of the concentrated formulations and is no greater than about 13, or a pH from about 11 to about 13. The pH of the concentrated formulations can be greater than the pH of the diluted formulations by an amount of from about 0.3 to about 1.5, or from about 0.5 to about 1.2 (i.e., range of increase in pH between diluted formulation and concentrated formulation).

The concentrated formulation can be provided in a dilute concentrate system or package in which the concentrated formulation is in a first (sealed) container, and a second (dispensing) container that is initially empty and has a larger volume than the first container is also provided as part of the package to facilitate formation of the dilute hypohalite formulation by combining some or all of the concentrated hypohalite formulation from the first container with water (e.g., tap water) in the second container, where the second container then stores the dilute hypohalite formulation until it is used.

In some example embodiments, the concentrated formulation can be provided in a small capsule, pod or other container that stores a small amount of the concentrated formulation of no greater than about 10 ounces (about 283 grams), such as no greater than about 5 ounces (about 142 grams), or from about 1 ounce (about 28 grams) to about 2 ounces (about 57 grams). In such embodiments, the entire amount of the concentrated formulation can be poured into the second container for combining with tap water to form the dilute formulation.

Alternatively, the first container can store an amount of concentrated formulation that is greater than a designated amount to be diluted for a given dilute formulation. In some example embodiments, the first container can include concentrated formulation and an enclosure, e.g., in the form of a lid or cap, that also functions as a measurement vessel by filling a portion of or the entire volume of the cap with concentrated formulation for dilution in the second container. In such embodiments, the first container can include 5 ounces or more of concentrated formulation, where a designated smaller amount of concentrated formulation, such as 1 ounce, is diluted to form the dilute formulation with tap water for use. This facilitates forming a number (e.g., 5 or more) of dilute formulations within the second container before the first container of concentrated formulation is entirely depleted (i.e., the concentrated formulation is entirely used).

The second (dispensing) container, which can be of greater size/volume in relation to the first container, can be in any form that facilitates storage of the dilute formulation as well as delivery or dispensing of the dilute formulation in any desired manner for its intended use. For example, the dilute formulation may be used as an additive in laundry or other cleaning operations for providing or enhancing cleaning and/or oxidative treatment/stain removal for clothing, blankets or other textiles. In such case, the second container may be in the form of a bottle or jug with a suitable opening or spout that facilitates pouring of dilute formulation from the second container. The second container can also include a lid or cap that also facilitates measurement of a suitable amount of dilute formulation to be added, e.g., to a laundry cycle. In other example embodiments, such as where the dilute formulation is used for cleaning, sanitizing and/or disinfecting an object or a surface, the second container can include enclosure structure comprising a dispenser such as a pump spray nozzle or other suitable delivery structure that facilitates delivery of the dilute formulation as a liquid stream, a spray or a mist from the second container.

Concentrated and dilute formulations as described herein have been found to be very stable for an extended period of time (e.g., for days without significantly altering the hypohalite amount in the formulations), thus providing a long shelf life for the formulations prior to as well as after dilution. It has been determined that the concentrated and dilute hypohalite formulations are shelf stable by substantially maintaining their compositions at an effective hypochlorite concentration within the formulations over a suitable time period.

In particular, a concentrated hypohalite formulation as described herein can be shelf stable such that an initial concentrated sodium hypochlorite level is maintained at greater than 50% of the initial concentrated sodium hypochlorite level after a period of about 48 hours and at a temperature of about 60° C.

A dilute hypohalite formulation as described herein can be shelf stable such that an initial dilute sodium hypochlorite level is maintained at greater than 50% of the initial dilute sodium hypochlorite level after 168 hours at 60°.

The hypohalite formulations and, in particular, the dilute hypohalite formulations as described herein (and containing no more than about 1% by weight hypohalite) are very effective in oxidative stain removal as well as in cleaning and antimicrobial/antibacterial/antiviral efficacy with regard to sanitizing or disinfecting objects or surfaces for a variety of different bacteria, fungi and viruses. Antibacterial and antiviral efficacy (resulting in a desirable kill/reduction) can be achieved with contact times of 10 minutes or less, and even 5 minutes or less for certain embodiments. For example, dilute hypohalite formulations as described herein are effective (i.e., cause a reduction in number, e.g., at least a 3 log reduction) against both gram-positive and gram-negative bacteria (e.g., Escherichia coli, Clostridioides difficile, Staphylococcus aureus, Salmonella enterica, etc.) within 10 minutes of exposure. In addition, dilute hypohalite formulations as described herein exhibit at least a 3 log reduction (e.g., at least a 5 log reduction, or even at least a 6 log reduction) in one or more viruses (e.g., Influenza A, Human Coronavirus, Human Rotavirus, Murine Norovirus, etc.) within 10 minutes of exposure.

In use, a user or consumer of the dilute concentrate system or package opens the first (sealed) container and also the empty second container and combines a portion or the entire amount of the concentrated hypohalite formulation (solute) with a suitable amount of water (solvent) at the designated dilution ratio (e.g., between 1:10 and 1:20) to form a dilute hypohalite formulation that is stored within the second container. The second container can include suitable indicia with specific numeric or other gradations/graduation marks (e.g., graduation marks, such as in ounces, printed as a graduation scale on an interior and/or exterior surface of the second container) to indicate a specified amount of concentrated formulation to add to the second container and then an amount of water to fill to a specific graduation mark or level in the second container that achieves the desired dilution ratio. Alternatively, the volume of the second container can be set so that the precise dilution ratio is achieved by adding water, after adding the concentrated formulation, to fill the entire volume (or a substantial portion thereof) of the second container. For example, for a 1:12 dilution ratio, 2 ounces of concentrated formulation can be added to the second container, followed by filling the second container with tap water to a specific level that corresponds with a graduation mark or level in the second container (or filling substantially the entire volume of the second container) that forms 24 ounces. Thus, the system or package facilitates easy formation of the dilute formulation by combining the concentrated formulation with water at the precise amounts to achieve the precise dilution ratio and corresponding hypohalite concentration as well as precise concentrations of other components within the dilute formulation that is contained within the second container.

### Examples

### Example 1—Concentrated and Dilute Hypohalite Formulations

A number of concentrated hypohalite formulations were prepared with amounts of each ingredient provided within the ranges as set forth in Table 1, while dilute hypohalite formulations was prepared by dilution of the concentrated hypohalite formulation with hard water (e.g., tap water or other hard water) at a dilution ratio ranging from 1:11 to 1:16 (parts concentrated formulation to parts tap water/hard water). For example, one ounce of concentrated hypohalite formulation mixed with 10 ounces of tap water forms a 1:11 dilution forming the diluted hypohalite formulation. Each of the dilute formulations for Examples 1B, 2B, 3B, 4B and 5B respectively corresponds with concentrated formulations for Examples 1A, 2A, 3A, 4A and 5A (i.e., concentrated formulations for Example 1A were diluted to form dilute formulations for Example 1B, concentrated formulations for Example 2A were diluted to form dilute formulations for Example 2B, etc.).

TABLE 1
Concentrated Hypohalite Formulations - pH ranging from 12-14

| | Amount in formulation (wt %) | | | | |
|---|---|---|---|---|---|
| | Example | Example | Example | Example | Example |
| Ingredient | 1A | 2A | 3A | 4A | 5A |
| Sodium | 1.9-3.3 | 3.9-5.0 | 5.0-6.9 | 4.5-6.1 | 3.9-5.1 |
| Hypochlorite | | | | | |
| Sodium | 0.18-0.34 | 0.21-0.4 | 0.33-0.51 | 0.26-0.41 | 0.22-0.42 |
| Hydroxide | | | | | |
| Sodium | 0.4-0.6 | 0.8-1.2 | 2.7-3.9 | 1.9-3.2 | 1.9-2.5 |
| Carbonate | | | | | |
| Anionic | 0.29-0.56 | 0.4-1.4 | 0.8-1.8 | 0.78-1.4 | 0.6-1.2 |
| Surfactant | | | | | |
| Sodium | 0.001-0.01 | 0.001-0.01 | 0.001-0.01 | 0.001-0.01 | 0.001-0.01 |
| Polyacrylate | | | | | |
| Fragrance | — | 0.03-0.15 | — | — | — |
| DI Water | Balance | Balance | Balance | Balance | Balance |
| Total | 100 | 100 | 100 | 100 | 100 |

TABLE 2
Dilute Hypohalite Formulations - pH ranging from 11-13

| | Amount in formulation (wt %) | | | | |
|---|---|---|---|---|---|
| | Example 1B | Example 2B | Example 3B | Example 4B | Example 5B |
| | (1:13 | (1:11 | (1:16 | (1:16 | (1:16 |
| Ingredient | dilution) | dilution) | dilution) | dilution) | dilution) |
| Sodium | 0.14-0.24 | 0.33-0.42 | 0.31-0.43 | 0.28-0.38 | 0.24-0.32 |
| Hypochlorite | | | | | |
| Sodium | 0.013-0.024 | 0.018-0.033 | 0.021-0.032 | 0.016-0.026 | 0.014-0.026 |
| Hydroxide | | | | | |
| Sodium | 0.029-0.043 | 0.067-0.1 | 0.17-0.24 | 0.12-0.2 | 0.12-0.16 |
| Carbonate | | | | | |
| Anionic | 0.021-0.04 | 0.033-0.12 | 0.05-0.11 | 0.049-0.088 | 0.038-0.075 |
| Surfactant | | | | | |
| Sodium | 0.000071-0.00071 | 0.000083-0.00083 | 0.000063-0.00063 | 0.000063-0.00063 | 0.000063-0.00063 |
| Polyacrylate | | | | | |
| Fragrance | — | 0.0025-0.0125 | — | — | — |
| Tap Water/ | Balance | Balance | Balance | Balance | Balance |
| Hard Water | | | | | |
| Total | 100 | 100 | 100 | 100 | 100 |

### Example 2—Antibacterial/Sanitization Efficacy of Dilute Hypohalite Formulations

Dilute hypohalite formulations as described in Example 1 were tested for antibacterial/sanitization/disinfection efficacy against Clostridioides difficile. The tests were conducted in accordance with U.S. Environmental Protection Agency procedures as outlined in SOP Numbers MB-28-08 and MB-31-07, where the formulation (e.g., via spray) was applied to sufficiently contact a surface occupied by each bacterial strain, and then measuring a reduction in bacteria count after a set contact time. The test results are provided in Table 3.

TABLE 3

| | Dilute | | |
|---|---|---|---|
| | hypohalite | | |
| Organism | formulation | Contact time | Result |
| Clostridioides difficile | Example 3B | 5 minutes | 6.38 log reduction |
| (ATCC 43598) | | | |
| Clostridioides difficile | Example 4B | 5 minutes | 6.38 log reduction |
| (ATCC 43598) | | | |
| Clostridioides difficile | Example 5B | 5 minutes | 6.15 log reduction |
| (ATCC 43598) | | | |

Further tests of dilute hypohalite formulations were conducted in accordance with U.S. Environmental Protection Agency procedures as outlined in SOP Number MB-05-16 for antibacterial/sanitization/disinfection efficacy against Staphylococcus aureus and Salmonella enterica. For each bacterial strain, 60 carriers were inoculated and treated with the formulation to determine how many of the carriers were still positive after treatment over a set period of time. The test results are provided in Table 4. In these test procedures, less than 5/60 is considered a passing test (effective sanitization), while 5/60 or greater is considered as failing.

TABLE 4

| | Dilute | | |
|---|---|---|---|
| | hypohalite | | |
| Organism | formulation | Contact time | Result |
| Staphylococcus aureus | Example 1B | 9.5 minutes | 2/60 |
| (ATCC 6538) | | | (Pass) |
| Salmonella enterica | Example 1B | 9.5 minutes | 0/60 |
| (ATCC 10708) | | | (Pass) |

The test results demonstrate an antibacterial/sanitizing efficacy of the dilute formulations with a contact no greater than 10 minutes and even no greater than 5 minutes for some bacterial strains, in which at least a 3 log reduction (e.g., at least a 5 log reduction, or at least a 6 log reduction) of the bacterial strain is achieved.

Thus, dilute hypohalite formulations as described herein are effective against both gram-positive and gram-negative bacteria within 10 minutes. For example, dilute hypohalite formulations as described herein can exhibit at least a 3 log reduction in Staphylococcus aureus population or a Salmonella enterica population within 10 minutes. Further, dilute hypohalite formulations as described herein can exhibit at least a 3 log reduction in Clostridioides difficile within 10 minutes or even within 5 minutes.

### Example 3—Antiviral/Disinfection Efficacy of Dilute Hypohalite Formulations

Dilute hypohalite formulations as described in Example 1 were tested for Antiviral/disinfection efficacy against the following viral strains: Influenza A, Human Coronavirus, Human Rotavirus, and Murine Norovirus. The tests were conducted in accordance with the ASTM E1053 method, where the formulation (e.g., via spray) was applied to sufficiently contact a surface occupied by each viral strain, and then measuring a reduction in bacteria count after a set contact time. The test results are provided in Table 5.

TABLE 5

| | Dilute | | |
|---|---|---|---|
| | hypohalite | | |
| Virus | formulation | Contact time | Result |
| Influenza A | Example 2B | 9.5 minutes | ≥6.00 log |
| (ATCC VR-544) | | | reduction |
| Human Coronavirus | Example 2B | 9.5 minutes | ≥3.75 log |
| (ATCC VR-740, Strain 229E) | | | reduction |
| Human Rotavirus | Example 2B | 9.5 minutes | ≥5.50 log |
| (ATCC VR-2018) | | | reduction |
| Murine Norovirus | Example 2B | 9.5 minutes | ≥6.25 log |
| (ATCC MNV1) | | | reduction |

The test results demonstrate an antiviral/disinfecting efficacy of the dilute formulations with a contact no greater than 10 minutes, in which at least a 3 log reduction of the viral strain is achieved. In particular, dilute hypohalite formulations as described herein can exhibit at least a 3 log reduction in Influenza A within 10 minutes. In addition, dilute hypohalite formulations as described herein can exhibit at least a 3 log reduction in Human Coronavirus within 10 minutes. Further, dilute hypohalite formulations as described herein exhibit at least a 5 log reduction in Murine Norovirus within 10 minutes. Thus, dilute hypohalite formulations as described herein exhibit at least a 3 log reduction in one or more viruses within 10 minutes.

### Example 4—Mold Decolorization Efficacy of Dilute Hypohalite Formulations

Dilute hypohalite formulations as described herein, such as those described for Example 1, are effective in treating surfaces affected with mold, particularly for dilute hypohalite formulations having a pH less than 12. An effective treatment of a surface affected with mold yields a visible decolorization of the mold which can be correlated with a percent mold decolorization.

In this example, mold decolorization is demonstrated by treatment of mold covered surfaces with the dilute hypohalite formulations and determining a percent mold decolorization by comparing pre-treatment to post-treatment. Porous, bisque tiles were stained with a deactivated mold solution of Aspergillus niger. Dilute hypohalite formulations were then applied (e.g., via spray) to the stained tiles. A digital image was taken of each treated tile and also an untreated/control tile for comparison purposes. Image analysis was then performed utilizing suitable image analysis software to determine a Percent Mold Decolorization value for each treated tile.

The Percent Mold Decolorization was determined utilizing techniques to isolate treated areas of mold, untreated areas of mold, and the tile background, where the images were converted to grayscale through extraction of the red color plane for subsequent pixel histogram data analysis. Pixel intensity measurements were based upon pixel values ranging from 1 (black/dirty) to 255 (white/clean). A 100% Clean Pixel Value was determined based upon a mean pixel intensity of a clean (no mold) tile area, while a 100% Dirty Pixel Value was determined based upon a mean pixel intensity of an untreated mold area. A Sample Mean Pixel Value was also determined for an area of a mold treated tile, and the Percent Mold Decolorization was then determined based upon the following formula:

Percent Mold Decolorization=[(Sample Mean Pixel Value−100% Dirty Mean Pixel Value)/(100% Clean Mean Pixel Value−100% Dirty Mean Pixel Value)]*100

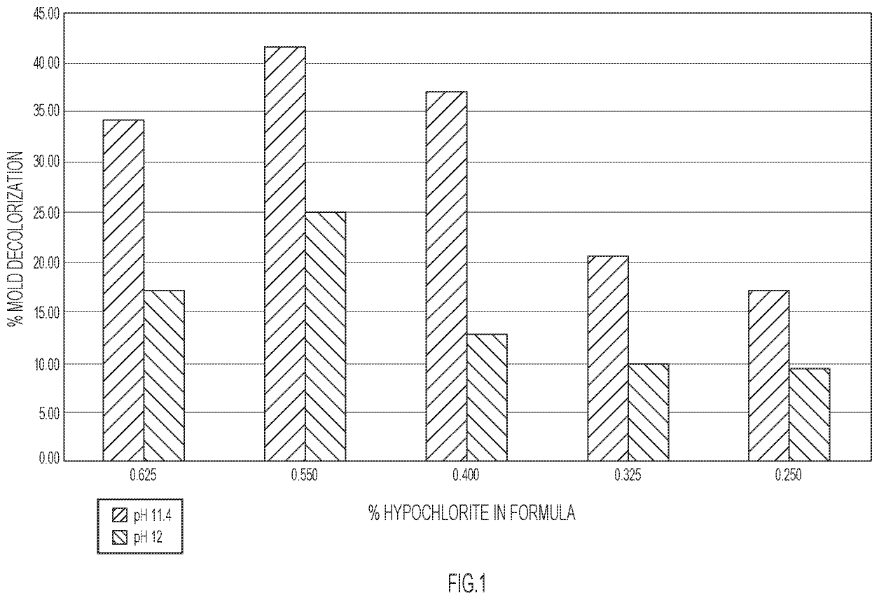

Dilute hypohalite formulations formed as described herein, and having hypochlorite concentrations ranging from 0.250-0.625 wt % and pH values at 12 and below 12 (pH of 11.4), were used to treat the mold covered tiles and % Mold Decolorization values were obtained. The results of such mold treatment tests are provided in FIG. 1. As can be seen from the plotted data, the dilute hypohalite formulations are more effective over the hypochlorite concentration range when the pH of the formulations are less than 12. In addition, hypochlorite concentrations described herein and having a pH less than 12 and including hypochlorite within a range from at least about 0.4% to about 1% by weight (i.e., by weight of the dilute hypohalite formulation) can be highly effective at discoloring mold when applied to surfaces including mold. Further, the data shows that the hypochlorite concentration in the dilute formulation within a range from about 0.4% to about 0.55 wt % (and where the dilute formulation has a pH less than 12) can be effective at discolorizing mold. In particular, dilute formulations including lower concentrations of hypochlorite that are no greater than 6% by weight can be effective in treating mold covered surfaces.

Thus, the formulations described herein facilitate the formation of dilute hypohalite formulations from concentrated hypohalite formulations, where the formulations are stable for with suitable shelf lives while maintaining efficacy in cleaning (e.g., mold decolorization) and antimicrobial/antiviral properties over their shelf lives. The concentrated formulations can further be diluted with tap water to form the dilute formulations without jeopardizing stability of the dilute formulations. The provision of a system or package that includes a concentrated formulation in a first container and an empty second container to receive and retain a diluted formulation also facilitates ease of conversion of the concentrated formulation to the dilute formulation for use.

While the invention has been described in detail and with reference to specific embodiments thereof, it will be apparent to one skilled in the art that various changes and modifications can be made therein without departing from the spirit and scope thereof.

What is claimed:

1. A concentrate dilution system comprising:
(A) a sealed container containing a concentrated hypohalite formulation comprising:
(i) about 2% to about 10% by weight of a sodium hypochlorite;
(ii) about 0.2% to about 5% by weight of a pH adjusting agent comprising one or more selected from the group consisting of: a carbonate, a hydroxide, and any combinations or mixtures thereof;
(iii) about 0.1% to about 2% by weight of an anionic surfactant; and
(iv) about 85% to 95% by weight of treated water;
wherein the concentrated hypohalite formulation has a pH of about 12-14 and has an initial concentrated sodium hypochlorite level that is maintained at greater than 50% of the initial concentrated sodium hypochlorite level after 48 hours at 60° C.; and
(B) a dispensing container having a greater volume than the sealed container, which is formatted to contain a stable dilute hypohalite formulation comprising:
(i) the concentrated hypohalite formulation; and
(ii) a tap water;
wherein the dilute hypohalite formulation has a pH of about 11-13 and is a 1:10-1:20 dilution of the concentrated hypohalite formulation with the tap water and the dilute hypohalite formulation includes sodium hypochlorite in a reduced amount of no greater than about 1% by weight.

2. The concentrate dilution system of claim 1, wherein the concentrated hypohalite formulation further comprises a stability agent comprising a polyacrylate.

3. The concentrate dilution system of claim 1, wherein the concentrated hypohalite formulation further comprises a fragrance.

4. The concentrate dilution system of claim 1, wherein the anionic surfactant comprises a sulfonate.

5. The concentrate dilution system of claim 1, wherein the concentrated hypohalite formulation comprises about 4% to 9% by weight of sodium hypochlorite.

6. The concentrate dilution system of claim 1, wherein the pH of the concentrated hypohalite formulation is about 0.5 to 1.2 higher than the pH of the dilute hypohalite formulation.

7. The concentrate dilution system of claim 1, wherein the dilute hypohalite formulation comprises about 0.1 to about 0.7% by weight of sodium hypochlorite.

8. The concentrate dilution system of claim 1, wherein the dilute hypohalite formulation is effective against both gram-positive and gram-negative bacteria within 10 minutes and exhibits at least a 3 log reduction in one or more viruses within 10 minutes.

9. The concentrate dilution system of claim 1, wherein the dilute hypohalite formulation exhibits at least a 3 log reduction in Staphylococcus aureus population within 10 minutes.

10. The concentrate dilution system of claim 1, wherein the dilute hypohalite formulation exhibits at least a 3 log reduction in Human Coronavirus within 10 minutes.

11. The concentrate dilution system of claim 1, wherein the dilute hypohalite formulation exhibits at least a 3 log reduction in Clostridioides difficile within 10 minutes.

12. The concentrate dilution system of claim 1, wherein the dilute hypohalite formulation exhibits at least a 5 log reduction in Murine Norovirus within 10 minutes.

13. The concentrate dilution system of claim 1, wherein the dilute hypohalite formulation with about 0.4% to less than 1.0% of sodium hypochlorite is effective at discoloring mold.

14. A concentrate dilution system comprising:
(A) a sealed container containing a concentrated hypohalite formulation comprising:
(i) about 2% to about 10% by weight of a sodium hypochlorite;
(ii) about 0.2% to about 5% by weight of a pH adjusting agent comprising one or more selected from the group consisting of: a carbonate, a hydroxide, and any combinations or mixtures thereof;
(iii) about 0.1% to about 2% by weight of an anionic surfactant;
(iv) about 0.0001 to about 0.01% of a stability agent comprising a polyacrylate; and
(v) about 85% to 95% by weight of treated water;
wherein the concentrated hypohalite formulation has a pH of about 12-14 and has an initial concentrated sodium hypochlorite level that is maintained at greater than 50% of the initial concentrated sodium hypochlorite level after 48 hours at 60° C.; and
(B) a dispensing container having a greater volume than the sealed container, which is formatted to contain a stable dilute hypohalite formulation comprising:
(i) the concentrated hypohalite formulation; and
(ii) a tap water;
wherein the dilute hypohalite formulation has a pH of about 11-12 and is a 1:10-1:20 dilution of the concentrated hypohalite formulation with the tap water and has an initial dilute sodium hypochlorite level that retains greater than 50% of the initial dilute sodium hypochlorite level after 168 hours at 60°.

15. The concentrate dilution system of claim 14, wherein the concentrated hypohalite formulation further comprises a fragrance.

16. The concentrate dilution system of claim 14, wherein the concentrated hypohalite formulation comprises about 4% to 9% by weight of sodium hypochlorite.

17. The concentrate dilution system of claim 14, wherein the pH of the concentrated hypohalite formulation is about 0.5 to 1.2 higher than the pH of the dilute hypohalite formulation.

18. A concentrate dilution system comprising:
(A) a sealed container containing a concentrated hypohalite formulation comprising:
(i) about 2% to about 10% by weight of a sodium hypochlorite;
(ii) about 0.2% to about 5% by weight of a pH adjusting agent comprising one or more selected from the group consisting of: a carbonate, a hydroxide, and any combinations or mixtures thereof;
(iii) about 0.1% to about 2% by weight of an anionic surfactant;
(iv) about 0.01 to about 1% of a fragrance; and
(v) about 85% to 95% by weight of treated water;
wherein the concentrated hypohalite formulation has a pH of about 12-14 and has an initial concentrated sodium hypochlorite level that is maintained at greater than 50% of the initial concentrated sodium hypochlorite level after 48 hours at 60° C.; and
(B) a dispensing container having a greater volume than the sealed container, which is formatted to contain a stable dilute hypohalite formulation comprising:
(i) the concentrated hypohalite formulation; and
(ii) a tap water;
wherein the dilute hypohalite formulation has a pH of about 11-12 and is a 1:10-1:20 dilution of the concentrated hypohalite formulation with the tap water and has an initial dilute sodium hypochlorite level that retains greater than 50% of the initial dilute sodium hypochlorite level after 168 hours at 60° and the dilute hypohalite formulation includes sodium hypochlorite in a reduced amount of no greater than about 1% by weight.

19. The concentrate dilution system of claim 18, wherein the concentrated hypohalite formulation further comprises a stability agent comprising a polyacrylate.

20. The concentrate dilution system of claim 18, wherein the anionic surfactant comprises a sulfonate.
